(19) United States
(12) Patent Application Publication
(10) Pub. No.: US 2010/0060004 A1
(43) Pub. Date: Mar. 11, 2010

(54) Frictionless Generator

(75) Inventor: Young Ho Ro, Glen Burnie, MD (US)

Correspondence Address: Young Ho Ro, 201 North Crain Highway, Apt. 4M, Glen Burnie, MD, 21061, US

(73) Assignee: Young Ho Ro, Glen Burnie, MD (US)

(21) Appl. No.: 12/457,072

(22) Filed: Jun. 1, 2009

Related U.S. Application Data
(60) Provisional application No. 61/136,432, filed on Sep. 5, 2008.

(51) Int. Cl. H02K 23/60

(52) U.S. Cl. 290/49

(57) ABSTRACT

New design of generator and or generators, which creates electricity. Using a sphere shape design compared to the traditional generator designs already in use today. Using a sphere shape design for the placements of the magnets and coil, triangular shape of the magnets, and a glass sphere filled with a gas, should allow for increase power output. This also allows for multiple layers to be used, dependent on power needs.

### CLAIM OF PRIORITY

This application claims the benefit of U.S. Provisional Application Ser. No. 61/136432 filed on Sep. 5, 2008, the entire contents of which are hereby incorporated by reference.

### DESCRIPTION

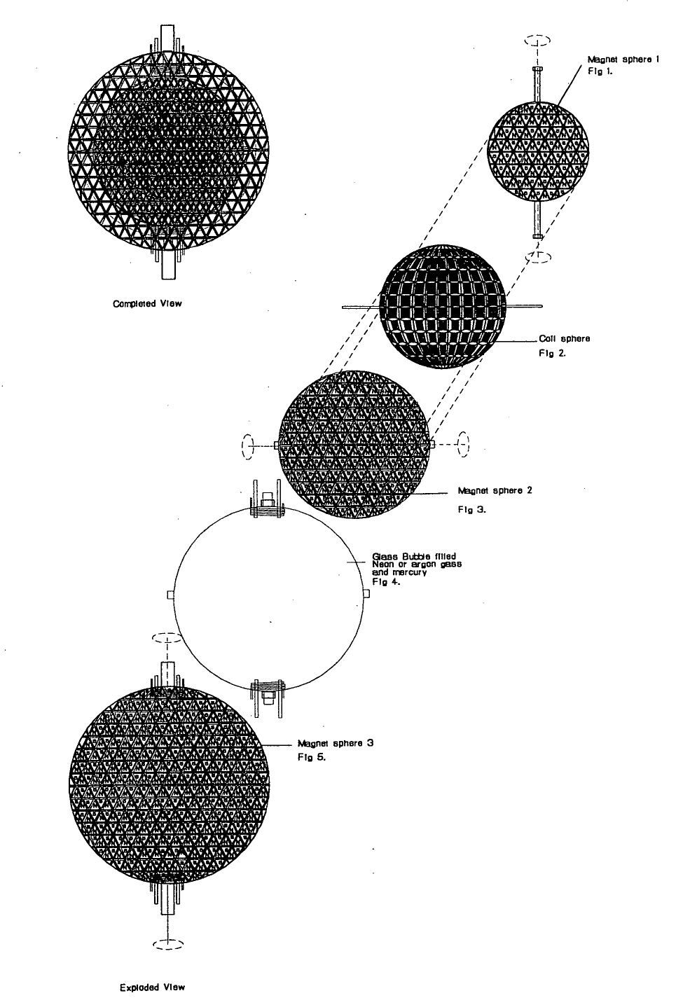

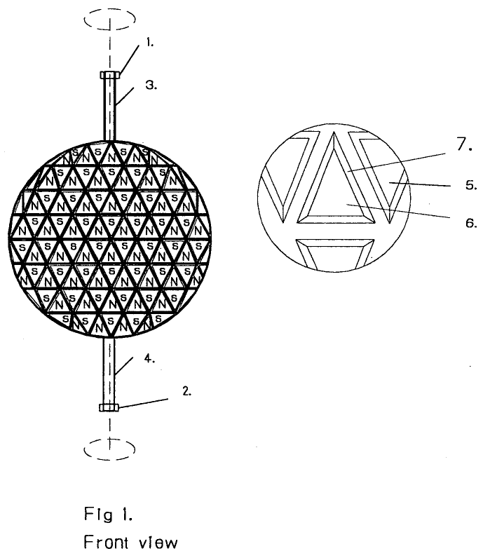

FIG. 1

Shows the inter-magnet sphere, known as magnet sphere 1. Which consist of a sphere shape metal framing (FIG. 1a ) around a light weight sphere shaped material. connected by a support rod, that provide the external force needed to rotate the magnet sphere 1. FIG. 1 shows ball bearing washer 1 and ball bearing washer 2 connected to the support rod at both ends. The external force moves the magnet sphere 1 to a clockwise rotation on the vertical axis. FIG. 1 also shows the placement of the magnets, which are arranged in a north, south order, within the given roll.

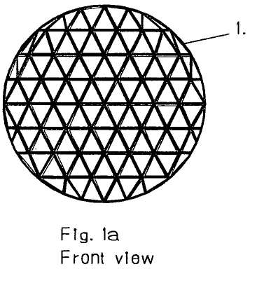

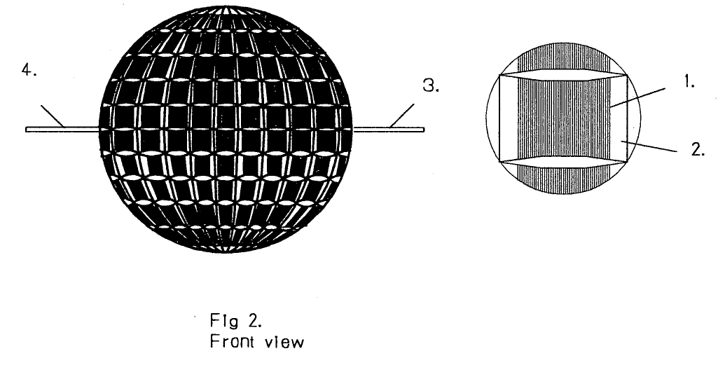

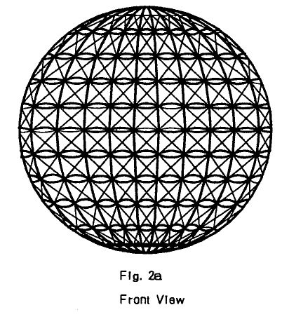

FIG. 2

Shows a ceramic sphere framing (FIG. 2a), Which is placed around the magnet sphere 1. Each copper wire coil, is connected to the opposite corresponding copper wire coil and or will remain independent. Positioning will be determined during testing, either at the opposite end of the corresponding top or bottom, left or right hemisphere or within the same hemisphere. Each section of coils may also be independent. Which ever generates the highest power output. To be determined during testing. The coil sphere is supported by the support rod 1 and 2. There is no output rods, because the electricity generated within the coil bundle, is released by charging the gas within the glass sphere.

1 800 963 2424

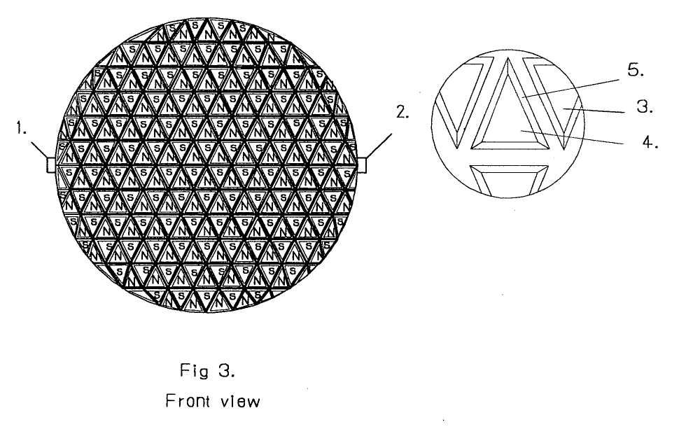

FIG. 3

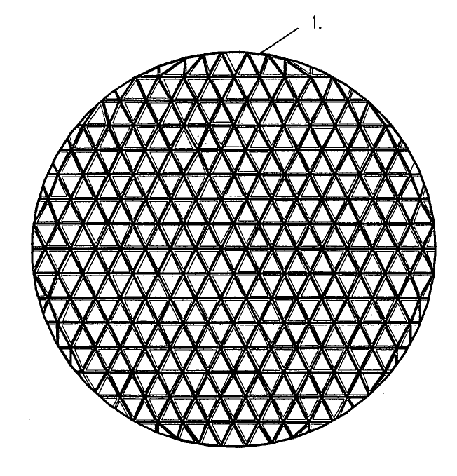

Shows the outer-magnet sphere, known as magnet sphere 2. Which also consist of a sphere shape metal framing (FIG. 3a). fixed around the wire coil. Fixed on the top and bottom of the magnet sphere 2, are ball bearing washer 1 and ball bearing washer 2. Which rotates the magnet sphere 2 counterclockwise on the horizontal axis. The placement of the magnets arranged to the corresponding magnetic field of the magnet sphere 1, all within the inside of magnet sphere 2. The magnetic field gives the push and pull needed to rotate magnet sphere 1. Magnets also placed on the outside of the sphere to connect to the magnet sphere 3 (FIG. 5) If needed, magnets can be placed on the outside of the sphere to create multiple layers.

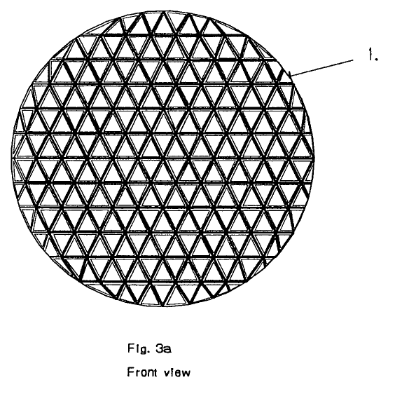

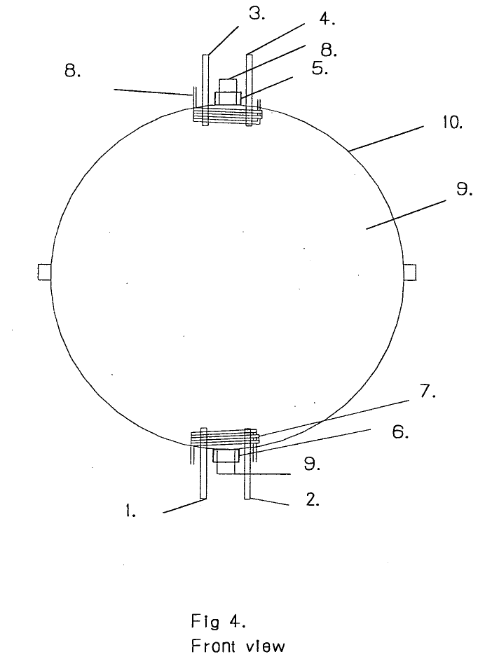

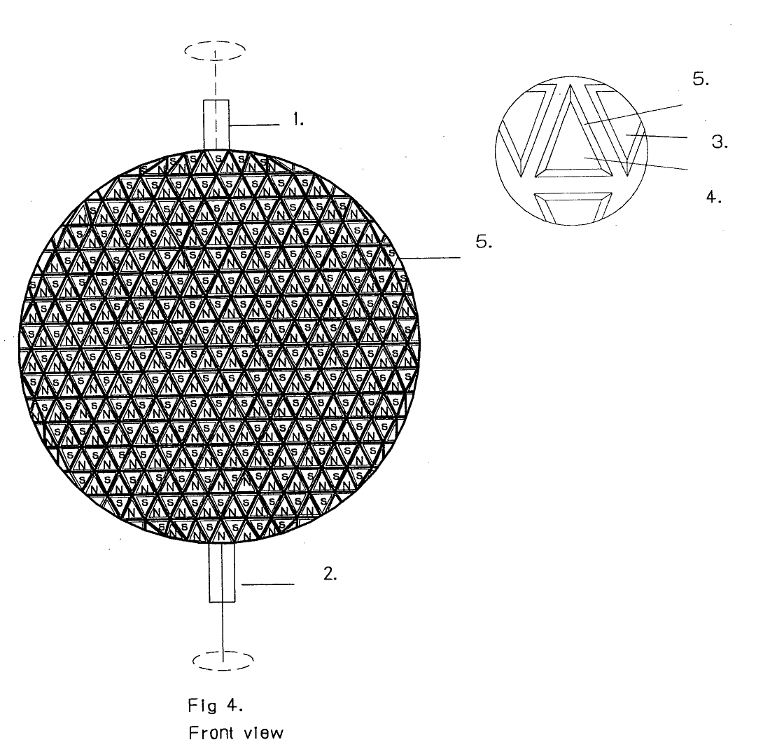

FIG. 4.

Shows the glass sphere 1. Which consist of Glass shape sphere, Rods 1, 2, 3, 4, Ball Bearing washer 1 and Ball Bearing washer 2, Coolant coil 1 and 2, and Neon and argon gas. The charge gas within the glass sphere, releases the energy through the rod 1, 2, 3, 4 to a delivery connection. For application that requires high output, using multiple layers, the delivery connection will require a glass tube filled with gas to store and distribute the power to the power grid. The ball bearing washer 1 and 2, will be connected to the magnet sphere 3, allowing the magnet sphere 3 to freely spin by a external force. Coolant coil 1 and 2 provides the hot and cold conversion within the glass sphere. This should prevent any type of over heating or melt down.

FIG. 5.

Shows the outer-magnet sphere, known as magnet sphere 3. Which also consist of a sphere shape metal framing (FIG. 4a). fixed around the glass sphere 1. Connected on the top and bottom of the glass sphere 1, of ball bearing 1 and ball bearing 2. Which rotates the magnet sphere 2 clockwise on it's vertical axis. The placement of the magnets arranged to the corresponding magnetic field of the magnet sphere 2, all within the inside of magnet sphere 3. The magnetic field gives the push and pull needed to rotate magnet sphere 2. If needed, magnets can be placed on the outside of the sphere to create multiple layers of coil spheres and magnet spheres and so dependent on the requirements.

### FUNCTION

The rotation of the magnet sphere 1 and the rotation of magnet sphere 2, creates the electricity when it passes the corresponding copper wire coil. If needed, this design can be fitted to have multiple layers of magnet sphere and the corresponding wire coil, then another magnet sphere and so on, all within the glass sphere Different shapes can be use with the layer configuration, for example a cylinder shape design, which require a different coil arrangements and design. For this model, the sphere shape is used. Until further testing is done. Possible design changes, could be the change of vertical and horizontal axis, changing all the spheres to rotate on the same axis.

1. Using a sphere shape design compared to the traditional generator designs already in use today.

2. Using a sphere shape design for the placements of magnets and coil, triangular shape of the magnets, and a glass sphere filled with a gas, should allow for increase power output.

3. This also allows for multiple layers to be used, dependent on power needs.
